(19) United States
(12) Patent Application Publication
(10) Pub. No.: US 2008/0014938 A1
(43) Pub. Date: Jan. 17, 2008

(54) System and method for suspending a wireless call while performing another wireless communications session

(75) Inventors: Thomas B. Hart, West Dundee, IL (US); Ronald T. Crocker, St. Charles, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/487,736

(22) Filed: Jul. 17, 2006

(51) Int. Cl. H04Q 7/20

(52) U.S. Cl. 455/435.1

(57) ABSTRACT

A call management system (136) and method that allows a first wireless voice call to be temporarily disconnected at a mobile device (130) while another communications session is performed from the same device (130). During a first voice call between a wireless communications device (130) and a second party, a network hold command is received. The second party is then placed on hold and wireless communications resources for the first wireless call are released. The wireless communications device (130) is subsequently reconnected to the second party. The reconnection includes removing the second party from hold and connecting the second party to the second voice call. A unit identifier (240) identifying the wireless communications device (130) is stored in an infrastructure database (114) along with an identifier of the first voice call to facilitate reconnection. Prior to reconnection, a wireless data communications session can be performed.

### FIELD OF THE INVENTION

The present invention generally relates to managing wireless voice and data calls and more particularly relates to suspending and resuming a wireless communications sessions.

### BACKGROUND OF THE INVENTION

Many mobile subscriber devices include a process to perform voice calls, such as cellular phone calls using 1xRTT, GSM, or other cellular voice communications techniques, and also to perform data communications. These devices generally do not support simultaneous voice and data communications since they share RF and other processing circuits between the voice and data communications functions. In order to obtain data through a data communications session during a voice call, these devices are required to end the voice call, perform the data communications session, and then the user must manually call the second party after performing the data communications. This is inconvenient and discourages a user from obtaining data, such as movie times and the like, that would be useful in the voice call.

Therefore a need exists to overcome the problems with the prior art as discussed above.

### SUMMARY OF THE INVENTION

According to an embodiment of the present invention, a computer implemented method for managing a wireless connection includes receiving, during a first wireless communications session between a wireless communications device and a second party, a network hold command. The method further includes maintaining, in response to receiving the network hold command, a telecommunications connection to the second party. The method additionally includes releasing, in response to receiving the network hold command, wireless communications resources for the first wireless communications session. The method also includes storing, in response to receiving the network hold command, an identifier identifying the wireless communications device. The method further includes connecting, subsequent to a delay after the releasing and based upon the identifier identifying the wireless communications device, the wireless communications device to the second party through a second wireless communications session.

According to another aspect of the present invention, a wireless voice call management system includes a network hold command processor that is adapted to receive, during a first wireless communications session between a wireless communications device and a second party, a network hold command. The wireless voice call management system further includes a wireless session resource controller that is communicatively coupled to the network hold command processor and that is adapted to release, in response to the network hold command processor's receiving the network hold command, wireless communications resources for the first wireless communications session. The wireless voice call processing system additionally includes a wireless session processor that is coupled to the network hold command processor and to the wireless session resource controller. The wireless session resource processor is adapted to maintain, in response to the network hold command processor's receiving the network hold command, a telecommunications connection to the second party. The wireless session processor further is adapted to store, in response to the network hold command processor's receiving the network hold command, an identifier identifying the wireless communications device. The wireless session processor is also adapted to connect, subsequent to a delay after the wireless voice resource controller releases and based upon the identifier identifying the wireless communications device, the wireless communications device to the second party through a second wireless communications session.

According to another aspect of the present invention, a mobile subscriber unit includes wireless communications circuits that are capable of supporting wireless voice communications and wireless data communications. The mobile subscriber unit also includes a network hold controller adapted to transmit a network hold command during a first wireless voice call, release, in response to sending the network hold command, assignment of the wireless communications circuits from the first wireless voice call, and transmit, subsequent to releasing the assignment, a network hold reconnect request in a second wireless voice call.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of wireless mobile communications system in accordance with an embodiment of the present invention.

FIG. 2 illustrates a block diagram of a wireless mobile subscriber unit in accordance with an embodiment of the present invention.

FIG. 3 is a flow chart illustrating a network hold process as performed by an embodiment of the present invention.

FIG. 4 is a flow chart illustrating a process for placing a call on network hold process, as is performed by an embodiment of the present invention.

FIG. 5 is a flow chart illustrating a process for network hold reconnect process as is performed by an embodiment of the present invention.

FIG. 6 is a flow chart illustrating a network hold reconnect process of a wireless mobile switching equipment computer system according to an embodiment of the present invention.

FIG. 7 is a block diagram illustrating a mobile switching equipment computer system according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

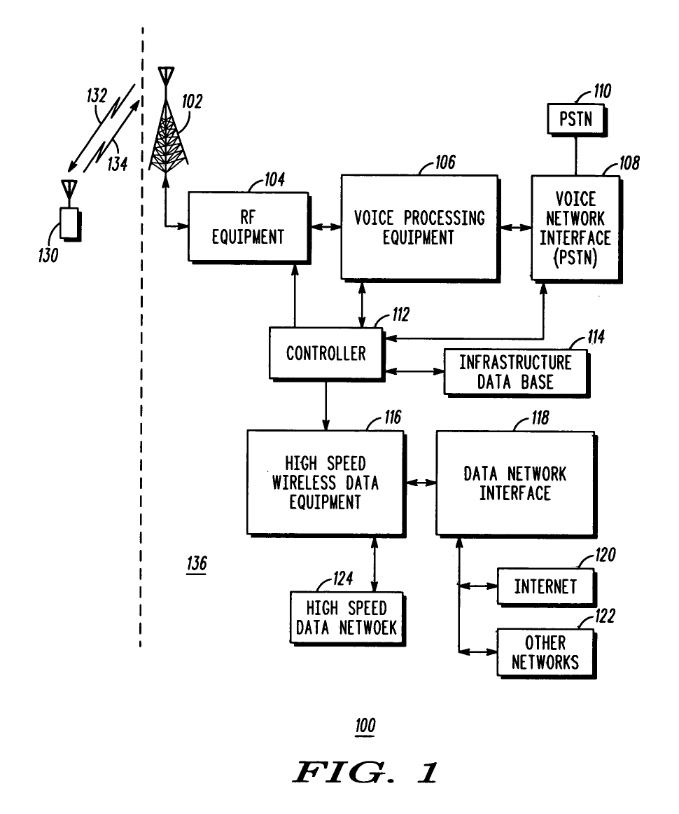

FIG. 1 is a block diagram of wireless mobile communications system 100 in accordance with an embodiment of the present invention. The wireless mobile communications system includes mobile switching equipment 136 and at least one wireless mobile subscriber device 130. The mobile switching equipment 136 is located, for example, at a base station or central office of a cellular telephone system. The mobile switching equipment 136 includes an antenna tower 102 and RF equipment 104. RF equipment 104 creates a wireless communications network that includes radio transmission and reception equipment to support simultaneous, bi-directional radio communications to couple the mobile switching equipment 136 and multiple mobile subscriber devices 130, such as cellular telephones, portable data devices, and the like, through wireless communications links. The RF equipment 104 supports, as is described in further detail below, bi-directional communications using either high speed wireless data communications and/or lower data rate voice communications. RF equipment 104, in combination with antenna tower 102, receives uplink signals transmitted from mobile subscriber devices 130 and transmits downlink signals to the mobile subscriber devices 130.

The mobile switching equipment 136 includes an automated controller 112. Automated controller 112, described in more detail below, controls the operation of the mobile switching equipment 136. Controller 112, for example, controls the assignment of radio frequencies for communications with the various wireless mobile subscriber devices 130. The controller 112 also controls the assignment of either low data rate voice or high data rate data communications resources for use by the various wireless mobile subscriber devices 130.

Controller 112 is in communication with an infrastructure database 114. The infrastructure database 114 maintains user subscriber information, such as account validity and services for which a particular user, and that user's associated mobile subscriber device, are authorized to use.

The RF equipment 104 exchanges baseband signals for low data rate digital voice communications with voice processing equipment 106. Further embodiments of the present invention perform wireless voice communications with any type of, or combination of, low data rate data communications equipment and analog wireless voice communications equipment. The wireless mobile communications system 100 of some embodiments of the present invention performs voice communications according to, for example, iDEN, GSM and/or CDMA cellular voice communication standards. The voice processing equipment further exchanges voice signals with a voice network interface 108. The voice network interface 108 provides an interface for the voice processing equipment 106 to the Public Switched Telephone Network (PSTN) 110. The mobile switching equipment 136 supports conventional voice cellular phone calling by connecting a wireless mobile subscriber device 130 to either another wireless mobile subscriber device 130 or to a voice call placed over the PSTN 110.

The RF equipment 104 further exchanges communications signals with high speed wireless data equipment 116. The high speed wireless data equipment 116 supports, for example EV-DO, GPRS, UMTS and/or HSDPA wireless communications between the mobile switching equipment 136 and one or more wireless mobile subscriber devices 130 over wireless data links 132 and 134. Further embodiments of the present invention support any type of data communications, with either high or low data communications speeds. The high speed wireless data equipment 116 further connects to a data network interface 118. The data network interface 118 provides data communications connections to, for example, the Internet 120 and/or other private or public data communications networks 122. The mobile switching equipment 136 supports data communications between a wireless mobile subscriber device 130 and, for example, the Internet 120 and/or the other public or private data networks 122. The high speed wireless data equipment 116 further connects to a high speed data network 124. The high speed data network 124 in this example connects the mobile switching equipment 136 to other infrastructure components to support high speed data exchange between the infrastructure operational elements and the wireless mobile subscriber devices 130.

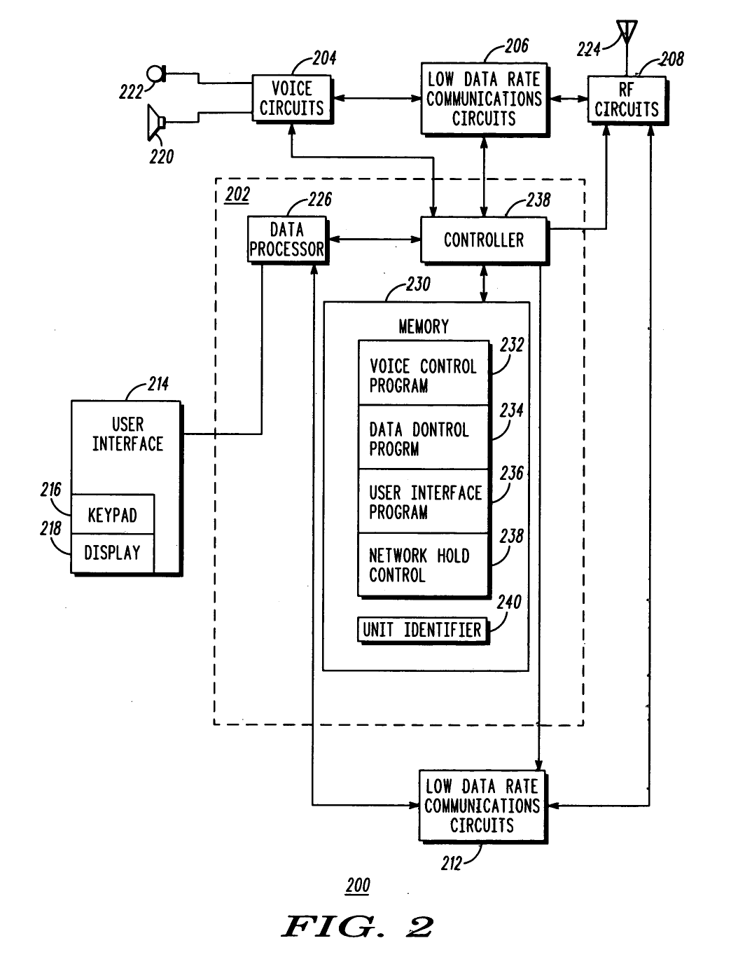

FIG. 2 illustrates a block diagram of a wireless mobile subscriber unit 200 in accordance with an embodiment of the present invention. The wireless mobile subscriber unit 200 is able to perform two-way voice communications over a wireless link using low data rate digital communications. The wireless mobile subscriber unit 200 is further able to perform two way high speed data communications. The wireless mobile subscriber unit 200 is able to perform either low speed data communications or high speed data communications, but is not able to perform both simultaneously. The wireless mobile subscriber units 200 are able change modes between wireless high speed data and wireless low speed data communications, but a current wireless communications session using one of these modes must be terminated prior to switching to and starting a communications session using the other mode.

Further embodiments of the present invention operate with mobile subscriber units that are able to perform, for example, simultaneous voice and data communications and invoke a network hold function for other reasons, such as an anticipated or predictable period of inactivity. Such anticipated or predictable periods of inactivity occur, for example if a caller receives an indication that there will be at least a five minute hold prior to reaching the intended person. Utilizing the network hold function of the present invention allows the user to save battery life and conserve RF system utilization.

The wireless mobile subscriber unit 200 includes RF circuits 208 that support wireless communications through an antenna 224 with, for example, mobile switching equipment 136, as is discussed above. The RF circuits 208 exchange data carrying signals over communications sessions through either low data rate voice communications circuits 206 or high data rate communication circuits 212. The RF circuits 208 are wireless communications circuits within the mobile subscriber unit 200 that perform required RF processing and signal conditioning to implement wireless data communications in the desired RF band according to protocols associated with the respective communications mode. The wireless mobile subscriber unit 200 performs wireless voice communications using conventional digital cellular voice communications using, for example iDEN, GSM and/or CDMA cellular voice communications standards. Further embodiments are able to use different wireless voice communications, such as, for example, analog voice communications or other digital voice communications.

The low data rate communications circuits 206 of the wireless mobile subscriber unit 200 perform voice call processing by exchanging voice signals with voice circuits 204. Voice circuits 204 of the embodiment accept voice signals from a microphone 222 and provide conditioned audio signals to a speaker 220 to provide an audio interface for the user. The voice circuits 204 then exchange signals representing the audio signals with the low data rate communications circuits 206.

In addition to voice call processing, the wireless mobile subscriber unit 200 is also able to perform data optimized wireless communications through wireless communications sessions that includes wireless communications between the wireless mobile subscriber unit 200 and the mobile switching unit 136. The wireless mobile subscriber unit 200 further includes a high data rate communications circuit 212 to support these high speed data communications functions. The wireless mobile subscriber unit 200 of the embodiment performs high speed data communications by using EV-DO wireless data communications protocols. Further embodiments of the present invention support dedicated user data communications by implementing other protocols, such as 1xRTT, GSM or any other suitable data communications protocol. The embodiment, however, incorporates wireless mobile subscriber units 200 that are able to communicate in only one mode of wireless communications at a time, i.e., wireless data communications can occur either by low data rate voice communications or high speed data communications, but not in both modes simultaneously. The operation of the embodiments of the present invention allow smooth switching between these two modes to facilitate interrupting a voice call to perform high speed data communications, as is described below. Further embodiments of the present invention are able to incorporate wireless mobile subscriber units that are able to simultaneously communicate in multiple modes at a time. These further embodiments release communications resources for one mode in order to, for example, conserve RF spectrum utilization.

The wireless mobile subscriber unit 200 includes digital data circuits 202. The digital data circuits 202 include a controller 228 that controls the operation of the wireless mobile subscriber unit 200 by issuing commands to and monitoring status of various components of the wireless mobile subscriber unit 200. The digital data circuits 202 include a memory 230 that includes both volatile and non-volatile data storage for use by controller 228. Memory 230 of the embodiment stores executable programs that are executed by controller 228 to perform its controlling functions.

Controller 228 executes programs stored in memory 230. Memory 230 includes a voice control program 232 that controls performance of voice calls through voice circuits 204, low data rate communications circuits 206 and RF circuits 208. Memory 230 also includes a data control program 234 to control high speed data communications using the high data rate communications circuit 212 and the RF circuits 208.

The wireless mobile subscriber unit 200 further includes a user interface 214 that includes a keypad 216 and a display 218. The user interface 214 communicates with a data processor 226 located within the digital data circuits 202. The data processor 226 creates alpha-numeric displays that are to be presented on the display 218. The data processor 226 further accepts keypad inputs from keypad 216 to perform control of the wireless mobile subscriber unit 200 and implement both voice and data communications. Further, data communicated over the high data rate communication circuit 212 are able to, at least in part, originate from keypad 216. Data received via a high speed data communications session is also able to be displayed, either directly or after processing by the digital data circuits 202, on display 218. The memory 230 also includes a user interface program that performs user interface input and output through the various components within user interface 214. Further embodiments of the present invention include user interfaces that include various other types of user interface components, such as voice recognition, handwriting recognition, and any other suitable data input and/or output components.

The memory 230 includes a network hold control program 238 that controls initiating and reconnecting a call from the network hold state. The memory 230 also includes a unit identifier, which is a unique identification dataset used to uniquely identify the particular wireless mobile subscriber unit 200. In the embodiment shown, the unit identifier includes the Electronic Serial Number (ESN) and/or the Mobile Identification Number (MIN) assigned to the particular mobile device.

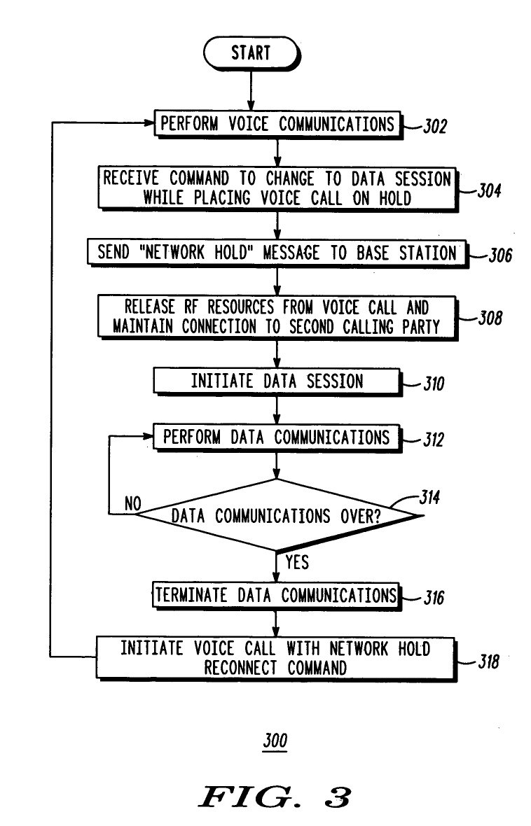

FIG. 3 is a flow chart to illustrate a handset network hold process 300 as performed by an embodiment of the present invention. The handset network hold process 300 is performed, for example, when a user of a wireless mobile subscriber unit 200 is engaged in a voice call that the user wishes to temporarily interrupt to perform a wireless data communications session. In order to perform this data communications session, the user places the voice call on hold, performs the wireless data communications session, and then resumes the voice call. This particular process is efficiently performed by the embodiment as described below.

The handset network hold process 300 begins by performing, at step 302, wireless voice communications between a wireless communications device and a second party in conjunction with the mobile switching equipment 136. Voice communications are able to be performed with a second party using either another wireless mobile subscriber unit 200 or with a second party using a conventional, landline telephone through the voice network interface 108 through the Public Switched Telephone Network (PSTN).

The handset network hold process 300 continues with the receipt, at step 304, of a command from a user of the wireless communication device initiating the call to change to a data session while placing the voice call on hold. This command is provided by a user input through, for example, pressing a button on the keypad 216 of the user interface 214 on the wireless mobile subscriber unit 200. In response to this command, the wireless communication device initiating the call in one embodiment sends, at step 306, a “network hold” message containing a network hold command to the mobile switching equipment 136. An example of the “network hold” command utilized by an embodiment of the present invention is a “flash command” or “feature code” transmitted to the mobile switching equipment 136, such as a particular control message sent to the mobile switching equipment 136 as part of the control communications between the wireless mobile subscriber unit 200 and the mobile switching equipment 136. The network hold command is able to be a flash command that contains a pre-determined feature code indicating the network hold command. This “Network Hold” command further includes the unit identifier 240 of the wireless mobile subscriber unit 200, such as that unit's Electronic Serial Number (ESN) or Mobile Identification Number (MIN). The unit identifier 240 uniquely identifies the wireless communications device.

Further embodiments of the present invention respond to network hold messages that originate from various sources. As described above, the network hold message is able to originate from a wireless mobile subscriber unit 200. Network hold messages are also able to originate from a processor receiving an input from a call center or other type of call answering system located at a site remote from the wireless mobile subscriber unit 200. For example, a call server or call answering system is able to provide an indication that a user is on hold to the mobile switching equipment 136, such as by providing an audio message indicating that the caller will be on hold for at least a number of minutes. The mobile switching equipment 136 detects this message and then places the wireless communications session on network hold, thereby releasing RF resources and conserving battery power for the wireless mobile subscriber unit 200. Mobile switching equipment 136 of further embodiments are able to have equipment configured to detect the audio message and react by generating a network hold command to cause the process to place the mobile subscriber unit 200 on network hold.

Yet further embodiments of the present invention are able to respond to network hold messages that originate from a cellular system being used by the wireless mobile subscriber unit 200. For example, in the case of an overload condition, the cellular system is able to send a network hold message to the mobile switching equipment 136 to reduce the load on the cellular system. A network hold command is further able to originate from, for example, a cellular phone billing system that will place the wireless mobile subscriber unit 200 on network hold during a period in which RF resources are more expensive.

The handset network hold process 300 continues with the release, at step 308, of the RF resources from the voice call with the wireless communication device and maintaining a telecommunications connection with the second party. The mobile switching equipment 136 is configured to recognize that when a wireless mobile subscriber unit 200 sends a “network hold” message, that wireless mobile subscriber unit 200 will release the RF resources from the voice call. Release of the RF resources includes halting all RF transmission and reception in connection with the voice call, thereby making those RF channels available for other calls. The process within the wireless mobile subscriber unit 200 similarly releases the assignment of RF circuits from the voice call so that the RF circuits are able to be used to support a data communications session by the wireless mobile subscriber unit 200. By releasing the RF or communications resources for a wireless session, those communications circuits and the RF channels used for the released wireless session are able to be assigned to other uses.

A telecommunications connection to the second party is maintained in this embodiment by, for example, placing the call on hold. In the case were the second party is using a wireless mobile subscriber unit 200, the RF resources for the connection to the second party are able to be released by using a similar “network hold” process as described above until reconnection to that wireless mobile subscriber unit 200 is required.

The handset network hold process continues by initiating from the wireless communication device initiating the call in one embodiment, at step 310, a data session. Some embodiments of the present invention initiate a data session in a conventional manner, such as by initiating an EV-DO data session. Prior to initiating this data session, the RF resources, such as RF circuits 208, had been released from the voice call and are available for a data communications session. Some embodiments of the present invention automatically initiate the date session after sending a network hold command, such as in response to a user pressing a specific key during a voice call that executes a command to enter a data communications session using the user interface of the wireless communication device. In an alternative to initiating a data session, some embodiments of the present invention are able to initiate a wireless voice communications session using either the same or a different wireless voice call technology as was used for the initial wireless voice call that was interrupted by transmission of the “network hold” message that was sent at step 306.

After the data session is initiated, the wireless communication device and the mobile switching equipment perform, at step 312, data communications. In some embodiments of the present invention, a single key press by a user is used to change a current voice call to a data session. In these embodiments, a single key press during a voice call proceeds to initiate, at step 306, sending a network hold message, release the RF resources, at step 308, and initiate the data communications, at step 310.

The handset network hold process 300 continues with a determination, at step 314, of whether or not the data communications session is over. A data session is determined to be over by either an explicit command being entered by a user, such as through the user interface 214, by determining that a pre-configured timeout period expired after the last data transfer, or by detecting that the second party has taken an action to terminate the network hold, such as is described below. If the data session is not over, the process returns to performing, at step 312, data communications.

Once it is determined, at step 314, that the data communications are over, the data communications session is terminated, at step 316. This termination is performed in the embodiment through conventional techniques, such as terminating an EV-DO session. The time of the data communications in this example provides a delay after the release of RF resources from the voice call, as performed in step 308.

After terminating the data communications session, the handset network hold process continues by initiating, at step 318, a second wireless communications session that consists of a voice call that includes a “network hold reconnect” command. The embodiment signifies the “network hold reconnect” command by initiating a voice call with a feature code that signifies the “network hold reconnect” function. An example of such a feature code is having the wireless mobile subscriber unit place a voice call by dialing the number “#3333” to signify that this is not a regular voice call, but rather a “network hold reconnect” call. The call initiation also includes the unit identifier, such as one or both of the ESN and MIN, as is performed in conventional wireless voice call initiations. The mobile switching equipment 136, in response to receiving the request to initiate a second wireless communications session that is indicated to be a “network hold reconnect” call, connects the wireless communications device to the second party.

Some embodiments of the present invention are able to initiate a voice call that includes a “network hold reconnect” command, in step 318, by using the same wireless network or wireless technology, such as iDEN, GSM, CDMA, and/or Internet Protocol Packet Data, that was used for the prior wireless voice call that was interrupted by sending the “network hold” message, at step 306. Further embodiments are able to initiate a voice call that includes a “network hold reconnect” command, at step 318, on the same wireless network that was used to for the prior wireless voice call.

As described below, the mobile switching equipment 136 had recorded in the infrastructure database 114 that the wireless mobile subscriber unit associated with this ESN and/or MIN has previously placed a voice call on “network hold.” The mobile switching equipment 136 responds to the “network hold reconnect” call initiation by searching the carrier's data base to determine, based upon the ESN and/or MIN of the wireless mobile subscriber unit 200 sending the network hold reconnect message, the voice call that had been placed on hold. The process then reconnects this wireless mobile subscriber unit 200 to that voice call with a second wireless communications session and removes that voice call from hold. In the embodiment of the present invention, the process steps of terminating, at step 316, the data communication session and initiating, at step 318, the voice call with the “network hold reconnect” message are both automatically performed without user intervention after the data session is determined, at step 314, to be over. As described above, the data communications session can be terminated by either an explicit user command, by a second party taking an action to terminate the network hold state, or by a timeout expiration after data transmission or a maximum time allowed for a data communications session when a voice call has been placed on network hold.

The above process advantageously allows a user of a wireless mobile subscriber unit to interrupt a voice call to obtain data that is needed for that voice call. This data is able to be obtained through a data communication session using the same RF resources of the wireless mobile subscriber unit 200. Further, this interruption is performed with minimum interaction by the user since the voice call is “placed on hold” to allow the data session, and the voice call is then resumed after the data session.

An application of using the “network hold” function to perform data communications would be a user speaking to a second person about seeing a particular movie. The user would like to visit the movie theater's web site to see available show times for that movie. The user of the wireless mobile subscriber unit 200 of the embodiment is able to select the network hold function, visit the website (which includes initiating and conducting a data communication session) to see the show times, terminate the data session, and automatically transmit a network hold reconnect command to cause the voice call to be automatically reconnected to the second person.

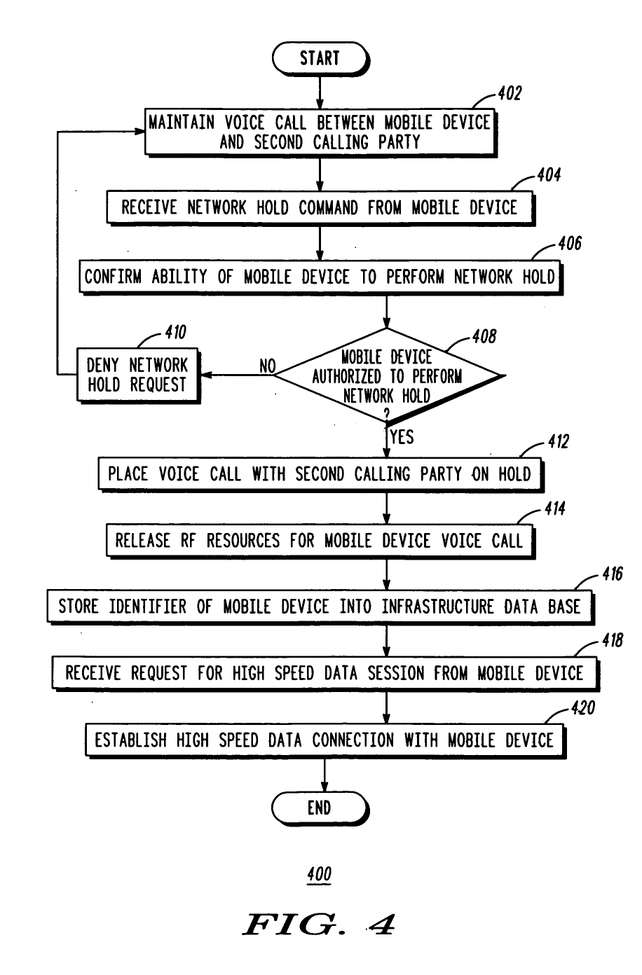

FIG. 4 illustrates a process 400 for placing a call on network hold, as is performed by an embodiment of the present invention. The placing a call on network hold process 400 is performed by the mobile switching equipment 136. The placing a call on network hold process 400 begins by maintaining, at step 402, a voice call between a mobile device and a second party. The second party in the embodiment is able to use either another mobile device or a landline telephone, or any other voice or low data rate communications device.

The placing a call on network hold process 400 continues by the mobile switching equipment's 136 receiving, at step 404, a “network hold” command from the wireless mobile device. As described above, the “network hold” command contains a unit identifier for the requesting wireless mobile subscriber unit. The process continues by the mobile switching equipment's 136 confirming, at step 406, the ability of the mobile device to perform the network hold function. This embodiment of the present invention performs this confirmation by searching the infrastructure database 114 to determine if this wireless mobile subscriber unit, and thereby its associated user, with the unit identifier contained in the “network hold” request is authorized to perform the “network hold” function. The process continues with the mobile switching equipment's 136 determining, at step 408, if the requesting wireless mobile subscriber unit is able, e.g., is authorized, to perform the “network hold” function. If the wireless mobile subscriber unit is not authorized to perform the “network hold” function, the network hold function request is denied, at step 410, and the process continues with maintaining the voice call, at step 402.

If it is determined, at step 408, that the wireless mobile subscriber unit is authorized to perform the network hold function, the voice call with the second party is placed, at step 412, on hold. In the case where the second party is connected through a wire-line voice call, the processing of the mobile switching equipment 136 places the voice call on hold through the voice network interface 108. In the case where the second party is connected through another wireless voice call connection, the wireless communication infrastructure places the call to the second party on hold and is also able to place the second party on a “network hold” status whereby RF resources for that wireless connection are also released. Embodiments of the present invention that maintain a call on hold are able to play a selected message to the second party, play music, or other processing as desired for a particular application.

The process 400 continues with the release, at step 414, of the RF resources at the mobile switching equipment 136 for the voice call to the requesting mobile device. The received unit identifier that is associated with the “network hold” request, along with an identifier of the call that has been placed on hold with the second party, is then stored, at step 416, into the infrastructure database 114 to identify the requesting wireless mobile subscriber unit and connect it with the second party that is placed on hold. The received unit identifier of some embodiments is delivered as part of the wireless communications protocol used to communicate between the wireless mobile subscriber units 200 and the mobile switching equipment 136.

The process stores the identifier of the call in association with the unit identifier, such as the ESN or MIN of the wireless mobile subscriber unit. The process is then able to subsequently retrieve the identifier of the call that has been placed on hold by supplying only the unit identifier, such as the ESN or MIN, to the infrastructure database 114. The ability to retrieve the identifier of the call that has been placed on hold by supplying only the unit identifier, such as the ESN or MIN, to the infrastructure database 114 provides a benefit of not requiring the mobile subscriber unit 200 to store an identifier of the call being placed on hold, and simplifies the process required by the mobile subscriber unit 200 and the mobile switching equipment 136, since processing of the receipt of the call identifier sent by the mobile subscriber unit 200, as is required in some prior art systems, is not required by the embodiments of the present invention.

The process then continues with the receipt, at step 418, of the request for a high speed data session from the requesting wireless mobile device 200. Some embodiments of the present invention automatically generate this request for a high speed data session, and some embodiments allow the user to manually generate this request, such as by operation of the user interface of the wireless mobile subscriber unit 200. In response to this request, the high speed data connection is then established, at step 420, with the wireless mobile device. The network hold process then terminates.

Further embodiments of the present invention operate to place the wireless mobile subscriber unit 200 in a mobility tracking state while the first communications session is placed on network hold and after the RF resources for that first wireless communications session have been released. A mobility tracking state performs the process to allow the mobile switching equipment 136 to maintain information as to the location of the wireless mobile subscriber unit 200. This process, for example, periodically determines which antenna tower 102, based on the position of the wireless mobile subscriber unit 200, is best able to communicate with the wireless mobile subscriber unit 200.

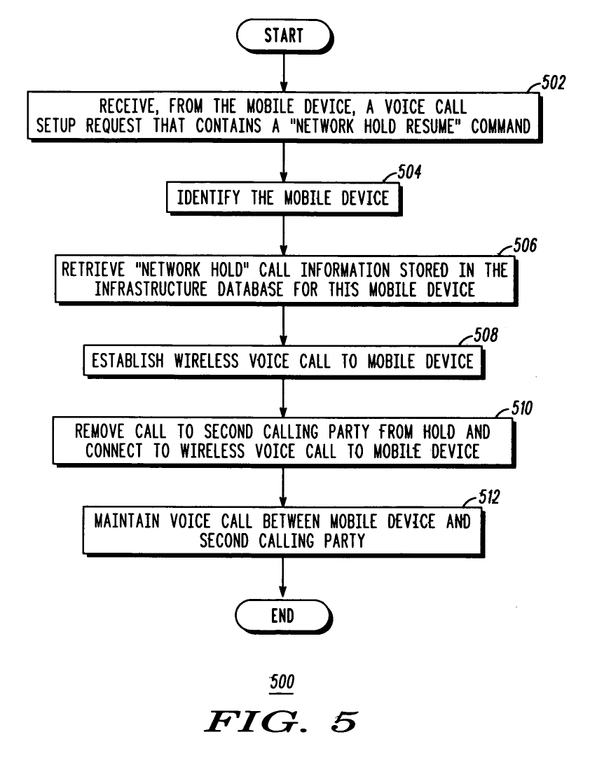

FIG. 5 illustrates a process 500 for network hold reconnect as is performed by an embodiment of the present invention. The network hold reconnect process 500 is generally performed after a high speed data session has been established by the network hold process, described above. The network hold reconnect process 500 begins with the receipt, at step 502, of a voice call setup request that contains a network hold reconnect command from the wireless mobile device. As described above, the network hold reconnect command is automatically transmitted by a wireless mobile device upon termination of a high speed data session conducted with a voice call on “network hold.”

Further embodiments of the present invention support issuing network hold reconnect command in other scenarios. For example, a network hold reconnect command is able to be transmitted in response to a manual initiation of a user. The “network hold reconnect” command is indicated by placing a wireless voice call with a specific, pre-determined, feature code. Further embodiments indicate the network hold reconnect command by any suitable method, such as by communicating a data message, in the form of a, for example, signaling command or a Short Message Service (SMS) message. The “network hold reconnect” command of various embodiments is able to be communicated between the wireless mobile device and the mobile switching equipment 136 through any suitable means.

The process 500 continues with the identification, at step 504, of the wireless mobile device 200 requesting the “network hold reconnect.” This identification is achieved by the unit identifier, such as the ESI or MIN, that is communicated with the network hold reconnect request. In some embodiments of the present invention, the unit identifier is communicated as part of the wireless communications protocol between the wireless mobile device 200 and the mobile switching equipment 136 and is not separately or explicitly communicated as part of the network hold reconnect message itself. The process continues with the receipt, at step 506, of the “network hold” call information that is stored in the infrastructure database 114 in association with this unit identifier. As described above, when the voice call was placed on “network hold,” the unit identifier for the requesting device and the second party's voice call connection were stored in the infrastructure database 114.

The process continues with the establishment, at step 508, of a wireless voice call with the wireless mobile device requesting the network hold reconnect. The call to the second party is then removed, at step 510, from hold and connected to the wireless voice call that was established with the requesting wireless mobile device. The process then continues by maintaining, at step 512, the voice call between the wireless mobile device and the second party.

The above description includes allowing a user to place a voice call on “network hold” to allow that user to use his or her wireless mobile device for a high speed data session. Further uses of the “network hold” do not require an additional communications session to be placed while the original voice call is placed on network hold. For example, a wireless device user may be involved in a voice call with a second party and anticipates entering an area with poor radio coverage, such as when entering an elevator shaft, tunnel, or other such area where cell phone coverage often “cuts out.” In such a case, a user is able to send a “network hold” request and have the mobile switching equipment 136 place the voice call with the second party on hold and place the wireless mobile subscriber unit 200 on network hold, thereby releasing the RF resources for that communications session. Once the user emerges from the area of poor radio coverage, such as when departing the elevator or tunnel, the user issues a “network hold reconnect” request and the voice call is reconnected. This greatly increases the convenience for the user who doesn't have to hang up and redial the second party's number in such situations.

Wireless mobile subscriber units 200 and/or the mobile switching equipment 136 of some further embodiments of the present invention are able to be configured to transmit the network hold command in response to at least one of predicting that the mobile communication device will enter an area of poor RF coverage, predicting that the user will be unable to communicate with a called party for at least a threshold number of minutes, determining a temporary overload condition of the RF communications infrastructure within a sector in which the mobile subscriber unit is operating, or determining a temporary increase in a cost of the wireless voice call.

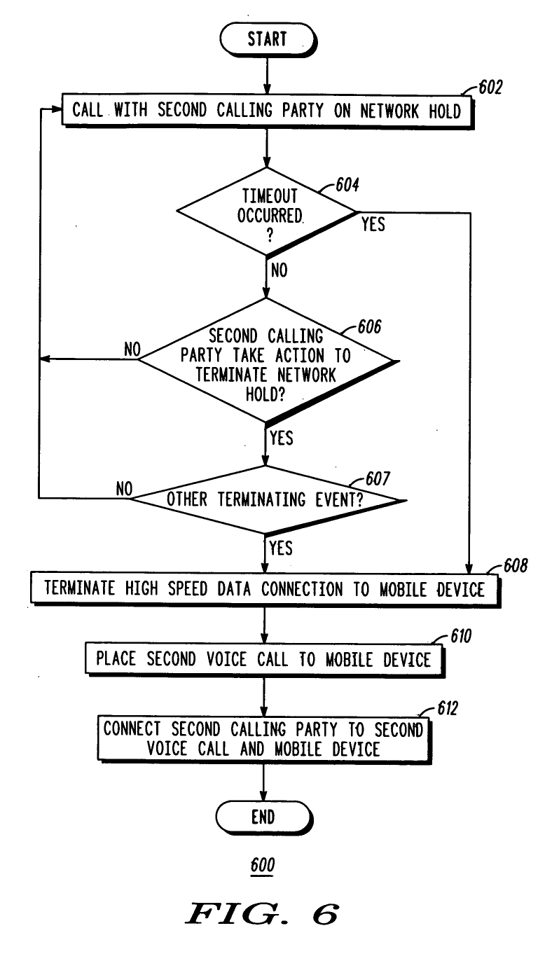

FIG. 6 illustrates a process 600 for an alternative network hold reconnect in accordance with an embodiment of the present invention. The alternative network hold reconnect process flow 600 begins with a call with a second party being on network hold. Placing a call on network hold is described in detail above. The process continues with a determination, at step 604, of whether or not a timeout has occurred. This timeout period is a predetermined timeout period that is measured either from the beginning of placing a call on network hold, or a measured time period after a last data transmission during a data communications session that occurred during the network hold state. If a timeout has not occurred, the process continues with a determination, at step 606, of whether or not the second party has taken action to terminate the network hold state. Such an action is able to include, for example, audio being sent from the second party that is detected by the system, the second party transmission of a particular DTMF code or sequence of DTMF codes, or other signaling methods originating with the second party. If the second party has not taken such action, the process returns to maintaining, at step 602, the call on network hold. The process continues with a determination, at step 607, of whether or not any other network hold terminating events have occurred. Other network hold terminating events include, for example, detection of a specific packet from a server, such as a call processor. If another network hold terminating event has not occurred, the process returns to maintaining, at step 602, the call on network hold.

Some embodiments of the present invention are able to allow the second party to take an action to terminate the network hold state. An example of the operation of such embodiments includes a network hold state where the second party is played a messages such as “are you a real person, if so, please press 1.” Such a scenario may assist if the second party is an automated answering system that makes the calling party, i.e., the person calling from the mobile device, wait for a customer service agent to answer. In this scenario, the caller using the mobile device decides to place the voice call on “network hold” and play the message prompting a person to press 1. The mobile switching equipment 136 is configured to recognize this key-press as an action taken by the second party to terminate the network hold state.

After a timeout has been determined to have occurred, after the second party has taken action to terminate the network hold state or after a network hold terminating event has been detected, the process continues with the termination, at step 608, of the high speed data connection with the mobile device. A second voice call to the mobile device is then placed, at step 610. The second party is then connected, at step 612, to the second voice call and the mobile device, thereby resuming voice communications between the mobile device and the second party.

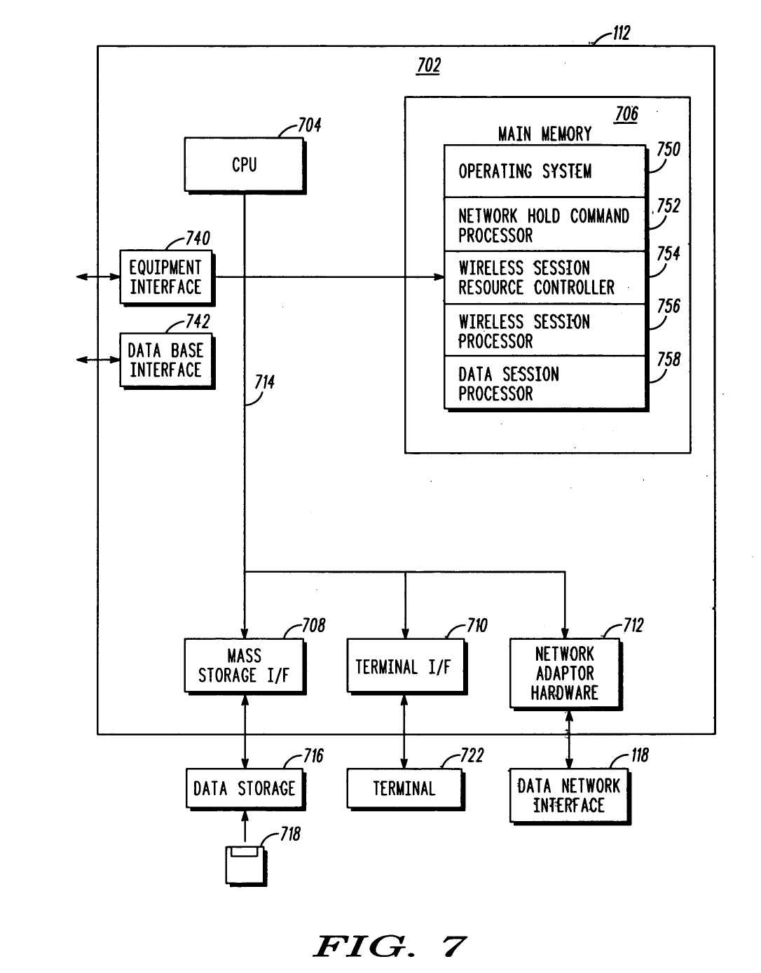

FIG. 7 is a block diagram illustrating a mobile switching equipment computer system 700 according to an embodiment of the present invention. The mobile switching equipment computer system 700 corresponds to the controller 112 of the mobile switching equipment 136 described above. Any suitably configured processing system is similarly able to be used as a mobile switching equipment computer system 700 by embodiments of the present invention, for example, a dedicated equipment controller, a personal computer, a workstation, or the like. The mobile switching equipment computer system 700 includes a computer 702. The computer 702 has a CPU 704 that is connected to a main memory 706, mass storage interface 708, terminal interface 710, network adapter hardware 712, equipment interface 740 and a database interface 742. A system bus 714 interconnects these system components.

The mass storage interface 708 is used to connect mass storage devices, such as data storage device 716, to the mobile switching equipment computer system 700. One specific type of data storage device is a computer readable medium such as a floppy disk drive, which may be used to store data to and read data from a floppy diskette 718 or CD (not shown). Another type of data storage device is a data storage device configured to support, for example, conventional mass storage file system operations.

The main memory 706 contains computer programs that control operation of the computer 702 to implement the various processes performed by the embodiment of the present invention. The main memory 706 includes a network hold command processor 752 that receives, from a wireless communications device during a first voice call between a wireless communications device and a second party, a network hold command. The main memory 706 further includes a wireless session resource controller 754 that releases, in response to the network hold command processor's receiving the network hold command, wireless communications resources for the wireless communications device. The main memory 706 includes a wireless session processor 756 that places, in response to receiving the network hold command, the second party on hold, and reconnects, in a second voice call, the wireless communications device to the second party. The wireless session processor 756 removes, as part of the reconnecting, the second party from hold and connects the second party to the second voice call. The main memory 706 also includes a data session processor 758 that controls high speed data communications sessions conducted by wireless communications devices.

Although illustrated as concurrently resident in the main memory 706, it is clear that respective components of the main memory 706 are not required to be completely resident in the main memory 706 at all times or even at the same time. In one embodiment, the computer 702 utilizes conventional virtual addressing mechanisms to allow programs to behave as if they have access to a large, single storage entity, referred to herein as a computer system memory, instead of access to multiple, smaller storage entities such as the main memory 706 and data storage device 716. Note that the term “computer system memory” is used herein to generically refer to the entire virtual memory of the computer 702.

Although only one CPU 704 is illustrated for computer 702, computer systems with multiple CPUs can be used equally effectively. Embodiments of the present invention further incorporate interfaces that each includes separate, fully programmed microprocessors that are used to off-load processing from the CPU 704. Terminal interface 710 is used to directly connect one or more terminals 722 to computer 702 to provide a user interface to the computer 702. These terminals 722, which are able to be non-intelligent or fully programmable workstations, are used to allow system administrators and users to communicate with the computer 702. The terminal 722 is also able to consist of user interface and peripheral devices that are connected to computer 702 and controlled by terminal interface hardware included in the terminal I/F 710 that includes video adapters and interfaces for keyboards, pointing devices, and the like.

Main memory 706 includes an operating system 750 that is a suitable multitasking operating system such as the Linux, UNIX, or other suitable computer operating system. Some embodiments of the present invention utilize architectures, such as an object oriented framework mechanism, that allows instructions of the components of operating system (not shown) to be executed on any processor in communication with this computer 702 The network adapter hardware 712 is used to provide an interface to the data network interface 118, described above. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via floppy disk, e.g. floppy disk 718, CD ROM, or other form of recordable media, or via any type of electronic transmission mechanism.

The present invention can be realized in hardware, software, or a combination of hardware and software. A system according to an embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows the computer to read data, instructions, messages or message packets, and other computer readable information. The computer readable medium may include non-volatile memory, such as ROM, Flash memory, Disk drive memory, CD-ROM, SIM card, and other permanent storage. Additionally, a computer medium may include, for example, volatile storage such as RAM, buffers, cache memory, and network circuits.

The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A machine implemented method for managing a wireless connection, the method comprising:
receiving, during a first wireless communications session between a wireless communications device and a second party, a network hold command;
maintaining, in response to receiving the network hold command, a telecommunications connection to the second party;
releasing, in response to receiving the network hold command, wireless communications resources for the first wireless communications session;
storing, in response to receiving the network hold command, an identifier identifying the wireless communications device; and
connecting, subsequent to a delay after the releasing and based upon the identifier identifying the wireless communications device, the wireless communications device to the second party through a second wireless communications session.

2. The method of claim 1, wherein the identifier comprises at least one of an electronic serial number and a mobile identification number.

3. The method of claim 1, wherein the network hold command is received through a flash command containing a pre-determined feature code indicating the network hold command and containing the identifier identifying the wireless communications device.

4. The method of claim 1, further comprising placing, subsequent to the releasing, the first mobile communication device into a mobility tracking state.

5. The method of claim 1, wherein the connecting is performed in response to at least one of an expiration of a pre-defined timeout, detection of audio from the second party, detection of a specific packet from a server, and detection of an action taken by the second party.

6. The method of claim 1, wherein the first wireless communications session uses a respective wireless network and the second wireless communication session utilizes the respective wireless network.

7. The method of claim 1, further comprising:
receiving, from the wireless communications device, a network hold reconnect request and the identifier identifying the wireless communications device, and
wherein the connecting is performed in further response to receiving the network hold reconnect request.

8. The method of claim 7, further comprising:
retrieving, in response to receiving the network call reconnect request, the identifier identifying the wireless communications device,
wherein the connecting comprises identifying the second party based upon the identifier identifying the wireless communications device.

9. The method of claim 7, wherein the network call reconnect request comprises a pre-determined feature code.

10. A wireless voice call management system, comprising:
a network hold command processor adapted to receive, during a first wireless communications session between a wireless communications device and a second party, a network hold command;
a wireless session resource controller, communicatively coupled to the network hold command processor, adapted to release, in response to the network hold command processor's receiving the network hold command, wireless communications resources for the first wireless communications session; and
a wireless session processor, commutatively coupled to the network hold command processor and to the wireless session resource controller, the wireless session resource processor adapted to:
maintain, in response to the network hold command processor's receiving the network hold command, a telecommunications connection to the second party;
store, in response to the network hold command processor's receiving the network hold command, an identifier identifying the wireless communications device; and
connect, subsequent to a delay after the wireless voice resource controller releases and based upon the identifier identifying the wireless communications device, the wireless communications device to the second party through a second wireless communications session.

11. The wireless voice call processing system of claim 10, wherein the voice call processor is adapted to connect the wireless communications device to the second party in response to at least one of an expiration of a pre-defined timeout, detection of audio from the second party, detection of a specific packet from a server, and detection of an action taken by the second party.

12. The wireless voice call processing system of claim 10 wherein the wireless session processor is further adapted to:
receive, from the wireless communications device, a network hold reconnect request, and
wherein the wireless session processor is further adapted to connect the wireless communications device to the second party in response to receiving the network hold reconnect request.

13. The wireless voice call processing system of claim 12, further comprising:
an infrastructure database, communicatively coupled to the network hold command processor and the wireless session processor, the infrastructure database adapted to store, in response to the network hold command processor's receiving the network hold command, the identifier identifying the wireless communications device, and
wherein the wireless session processor is further adapted to:
retrieve, in response to receiving the network hold reconnect request, the identifier from the infrastructure database; and
identify, in response to receiving the network hold reconnect request, the second party based upon the identifier, and
wherein the wireless session processor is adapted to connect, in response to receiving the network hold reconnect request, the wireless communications device to the second party based upon the identifier.

14. The wireless voice call processing system of claim 13, wherein the network call reconnect request comprises a pre-determined feature code.

15. The wireless voice call processing system of claim 10, further comprising:
at least one wireless communications device, communicatively coupled to the network hold command processor, that transmits the network hold command to the network hold command processor and releases, in response to transmitting the network hold command, wireless communications resources within the wireless communications device;

16. The wireless voice call processing system of claim 15, wherein the at least one wireless communications device further comprises wireless data communications resources, and wherein the wireless communications device establishes, in response to transmitting the network hold command, a wireless data communications session.

17. The wireless voice call processing system of claim 16, wherein the wireless communications device further terminates the wireless data communications session and transmits, in response to terminating the wireless data communications session, a network hold reconnect message to the wireless session processor.

18. A mobile subscriber unit, comprising:
wireless communications circuits capable of supporting wireless voice communications and wireless data communications; and
a network hold controller adapted to:
transmit a network hold command during a first wireless voice call;
release, in response to sending the network hold command, assignment of the wireless communications circuits from the first wireless voice call; and
transmit, subsequent to releasing the assignment, a network hold reconnect request in a second wireless voice call.

19. The mobile subscriber unit of claim 19, wherein the network hold controller transmits the network hold command in response to at least one of:
predicting that the mobile subscriber unit will enter an area of poor RF coverage;
predicting that a user will be unable to communicate with a called party for at least a threshold number of minutes;
determining a temporary overload condition of an RF infrastructure within a sector in which the mobile subscriber unit is operating; and
determining a temporary increase in a cost of the first wireless voice call.

20. The mobile subscriber unit of claim 18, further comprising a data communications controller, communicatively coupled to the network hold controller, the data communications controller adapted to:
initiate, in response to transmission of the network hold command, a wireless data communications session; and
terminate, subsequent to the initiation, the wireless data communications session, and
wherein the network hold controller transmits the network hold reconnect request in response to termination of the wireless data communications session.
